(19) United States
(12) Patent Application Publication
(10) Pub. No.: US 2012/0200096 A1
(43) Pub. Date: Aug. 9, 2012

(54) FUEL TANK LATCH

(75) Inventors: Paul L. Galloway, New Carlisle, OH (US); Erin Elizabeth Sutton, Perrysburg, OH (US)

(73) Assignee: MONTGOMERY MOTOR SPORTS, INC., Clayton, OH (US)

(21) Appl. No.: 13/365,927

(22) Filed: Feb. 3, 2012

Related U.S. Application Data
(60) Provisional application No. 61/439,638, filed on Feb. 4, 2011.

(51) Int. Cl. E05C 1/10; B23P 11/00; E05C 1/08

(52) U.S. Cl. 292/145; 292/137; 29/428

(57) ABSTRACT

A fuel tank latch is disclosed for securing a pivotable gas tank on a motorcycle. The fuel tank latch provides a way to tilt up the fuel tank to access components located beneath the fuel tank. When in its normal, non-tilted position, the forward end of the fuel tank may be secured to the motorcycle's chassis. The fuel tank latch releaseably couples a first mount and a second mount of a fuel tank to a first receiving pin and a second receiving pin of a chassis. The fuel tank latch may include a cover plate, a latch, a base plate, and an attachment plate. Example fuel tank latches according to the present disclosure may be configured to releaseably latch together the mounts and pins. A knob may be provided to allow operation of an internal latch assembly. The fuel tank latch may be used to secure components other than a gas tank to motorcycle.

### CROSS-REFERENCE TO RELATED APPLICATION

This application claims the benefit of U.S. Provisional Application No. 61/439,638, filed Feb. 4, 2011, which is hereby incorporated by reference.

### BACKGROUND

The present disclosure includes, inter alia, latch mechanisms, such as latch mechanisms that may be used to secure a pivotable gas tank on a motorcycle.

### SUMMARY

Latch mechanisms are generally disclosed. Some example embodiments include a method, process, system, apparatus, or device associated with latch mechanisms for a pivotable gas tank on a motorcycle.

In an example embodiment, a fuel tank latch releaseably couples a first mount and a second mount of a fuel tank to a first receiving pin and a second receiving pin of a chassis. The fuel tank latch includes an attachment plate with a generally longitudinally oriented opening to engage a first mount of a fuel tank, and a generally laterally oriented opening disposed substantially opposite of the generally longitudinally oriented opening and configured to engage a second mount associated with the fuel tank, the attachment plate being substantially flat. A base plate substantially rigidly mounts to the attachment plate. A cover plate substantially rigidly mounts to the base plate.

A latch is longitudinally slidably disposed between the base plate and the cover plate The latch includes a first keyhole slot configured to selectively engage a first receiving pin extending from a chassis and a second keyhole slot configured to selectively engage a second receiving pin extending from the chassis.

The fuel tank latch has a cover plate with a generally longitudinally oriented slot and a knob mounted to the latch and extending outward through the slot of the cover plate. The fuel tank latch includes at least one fastener extending through and coupling together the cover plate, the latch, the base plate, and the attachment plate, where at least one fastener extends through a generally longitudinally oriented slot in the latch to permit limited longitudinal movement of the latch. The base plate includes a first cutout for receiving at least a portion of the first mount therein, and the base plate includes a second cutout for receiving at least a portion of the second mount therein.

The fuel tank latch has a first keyhole slot configured to releaseably engage a first generally circumferential groove in the first receiving pin, The second keyhole slot is configured to releaseably engage a second generally circumferential groove in the second receiving pin. Each of the first and second keyhole slots includes a narrow portion and a widened portion. A spring arranged to bias the latch generally towards the widened portions of the first and second keyhole slots.

The fuel tank latch may be installed by engaging a first end of a fuel tank latch with a first mount associated with a fuel tank and engaging a second end of the fuel tank latch with a second mount associated with the fuel tank by pivoting the fuel tank latch about the first mount. Engaging the first end of the fuel tank latch with the first mount includes receiving the first mount in a generally longitudinally oriented opening associated with the first end of the fuel tank latch. Engaging the second end of the fuel tank latch with the second mount includes receiving the second mount in a generally laterally oriented opening associated with the second end of the fuel tank latch.

The fuel tank latch operates by pivoting a fuel tank to engage a first mount and a second mount disposed on the fuel tank with a first receiving pin and a second receiving pin disposed on a chassis, respectively. Then, engage a latch of a fuel tank latch with the first receiving pin and the second receiving pin, the fuel tank latch being mounted to the first mount and the second mount.

Engagement of the latch of the fuel tank latch to the first receiving pin and the second receiving pin may be accomplished by sliding the latch to a disengaged position, receiving at least a portion of the first receiving pin and at least a portion of the second receiving pin within the fuel tank latch, and sliding the latch to an engaged position in which the latch is releaseably secured to the first receiving pin and the second receiving pin.

Disengagement of the latch from the first receiving pin and the second receiving pin may be accomplished by sliding the latch, using a knob mounted to the latch and extending outward from the fuel tank latch. Pivot the fuel tank to disengage the first mount from the first receiving pin and the second mount from the second receiving pin.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure, and are, therefore, not to be considered limiting of its scope. The disclosure will be described with additional specificity and detail through use of the accompanying drawings.

In the drawings:

FIG. 1 is a perspective view of an example fuel tank latch 100 in a partially installed position;

FIG. 2 is a perspective view of an example fuel tank latch 100 in a fully installed position;

FIGS. 3A and 3B are exploded perspective views of an example fuel tank latch 100;

FIG. 4 is plan view of an example fuel tank latch cover plate 300;

FIG. 5 is an end view of an example fuel tank latch cover plate 300;

FIG. 6 is a plan view of an example fuel tank latch latch 400;

FIG. 7 is a plan view of an example fuel tank latch base plate 500. Similar to slot 312 on cover plate 300, slot 516 may be offset towards hole 510;

FIG. 8 is a front view of an example fuel tank latch base plate 500;

FIG. 9 is a cross-sectional view of an example fuel tank latch base plate 500;

FIG. 10 is a plan view of an example fuel tank latch attachment plate 600;

FIG. 11 is a perspective view of example receiving pins 206, 208 with circumferential grooves 216, 218 respectively;

FIG. 12 is a perspective view showing an example placement of mounts 202, 204 on fuel tank 200.

### DETAILED DESCRIPTION

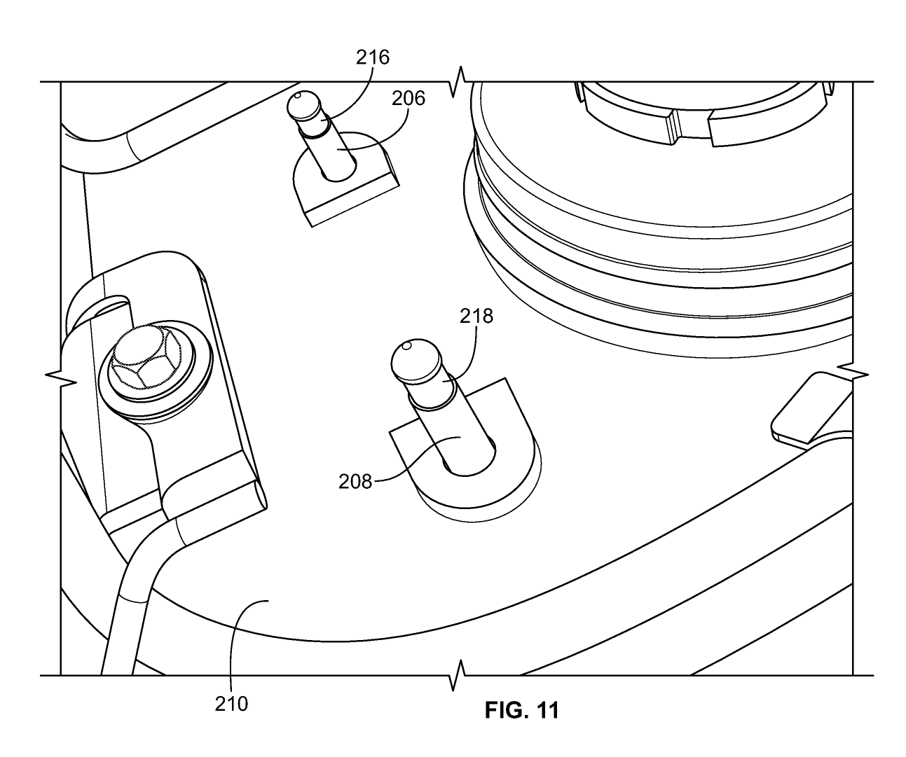

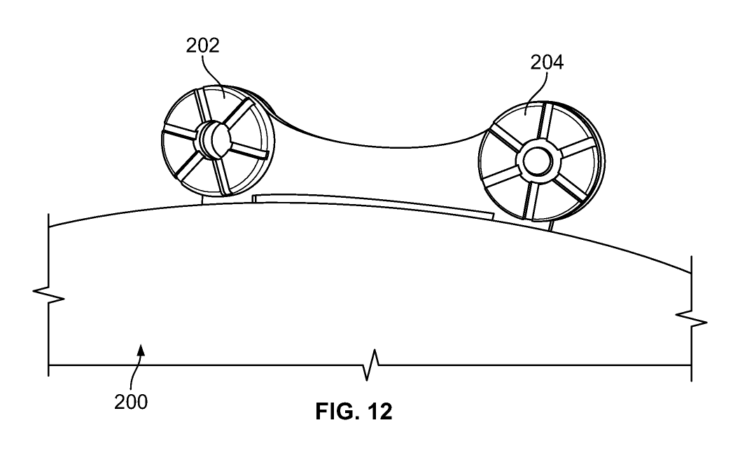

The present disclosure contemplates that some maintenance and/or repair procedures for some motorcycles may include tilting up the motorcycle's fuel tank to access components located generally beneath the fuel tank. For example, on Suzuki Hayabusa motorcycles, the fuel tank may be tilted generally rearward (e.g., the forward portion of the fuel tank may be raised) to allow access to components beneath the fuel tank. The fuel tank may be held in a tilted position using a prop rod or similar device, which may support the raised forward end of the fuel tank. When in its normal, non-tilted position, the forward end of the fuel tank may be secured to the motorcycle's chassis. For example, the forward end of the fuel tank 200 may include one or more mounts 202, 204 configured to releaseably receive one or more pins 206, 208 extending generally upwardly from the chassis 210 (see e.g., FIGS. 11 and 12). Some example pins 206, 208 may include one or more surface features such as, but not limited to, one or more circumferential grooves 216, 218. Some example fuel tank latches according to the present disclosure may be configured to releaseably latch together the mounts 202, 204 and/or the pins 206, 208.

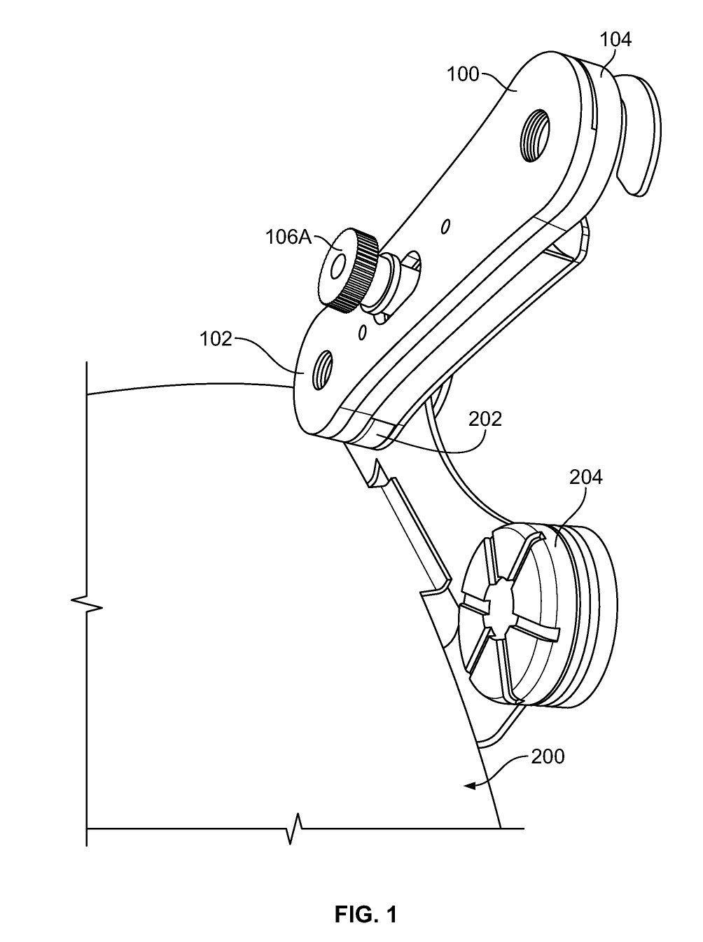

FIG. 1 is a perspective view of an example fuel tank latch 100 in a partially installed position on mounts 202, 204 associated with fuel tank 200. A first end 102 of fuel tank latch 100 may be engaged with and at least partially rotatable about a first mount 202. Rotation about first mount 202 may permit a second end 104 of fuel tank latch 100 to selectively engage a second mount 204. A knob 106A may be provided to allow operation of an internal latch assembly as described below.

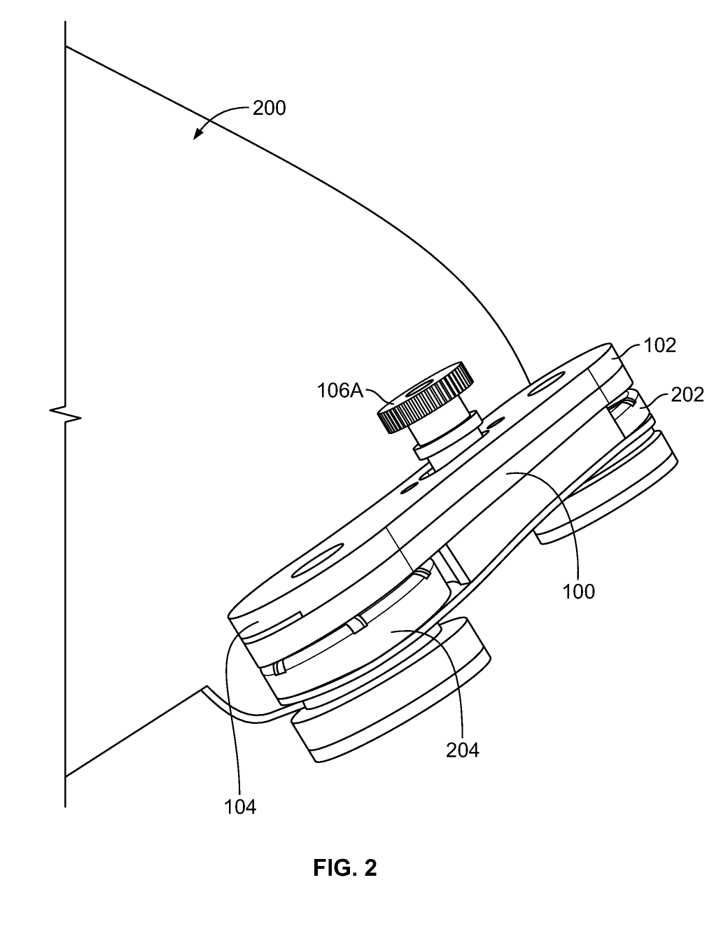

FIG. 2 is a perspective view of an example fuel tank latch 100 in a fully installed position. In the fully installed position, second end 104 of fuel tank latch 100 may releaseably engage second mount 204.

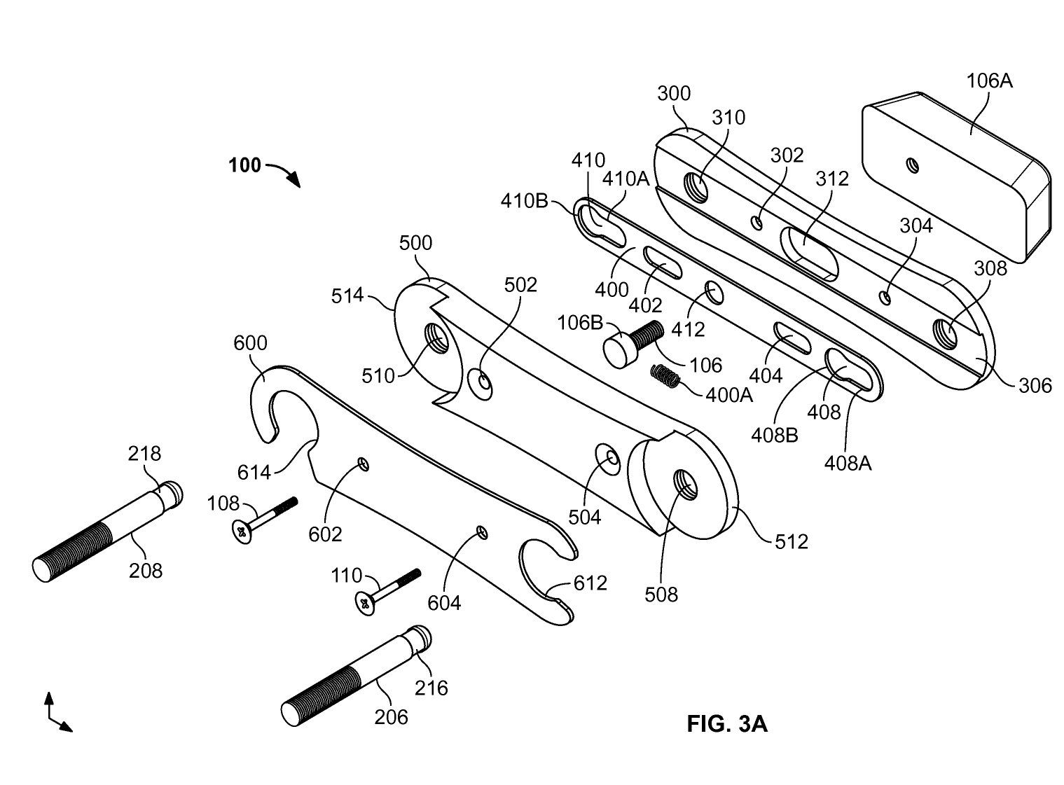

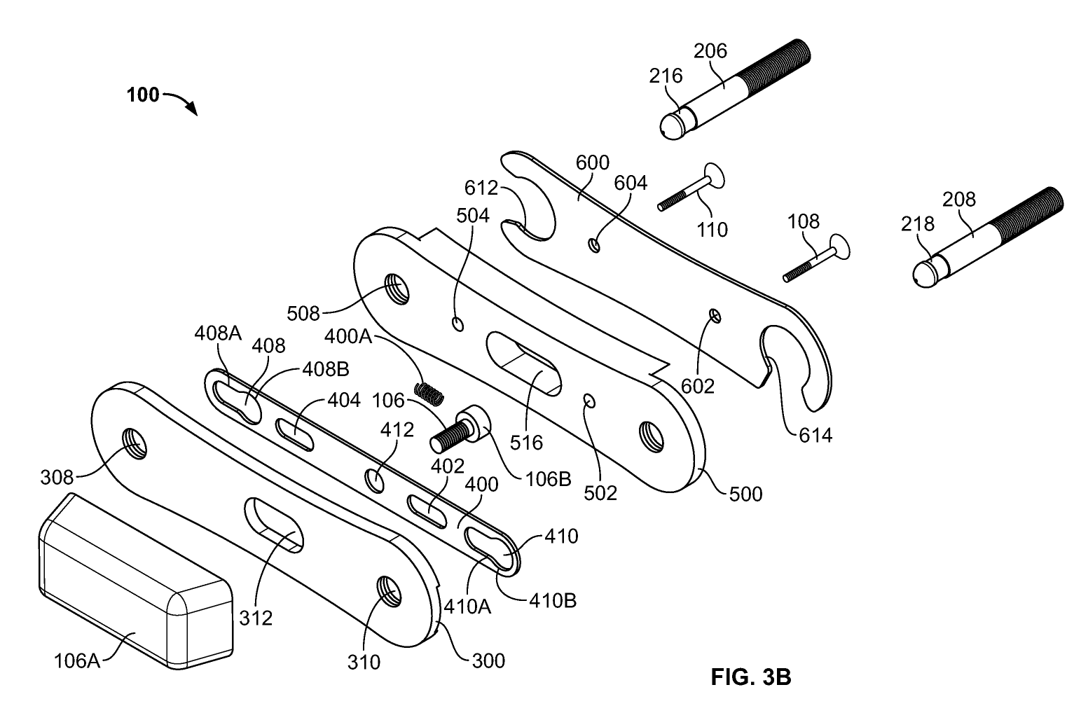

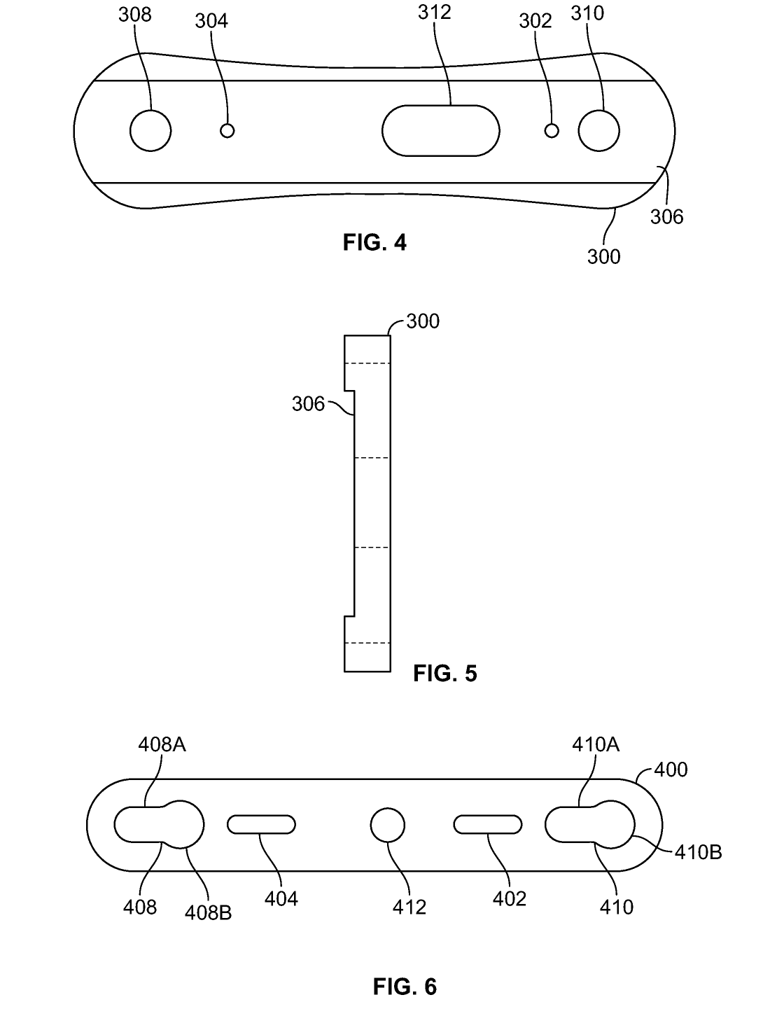

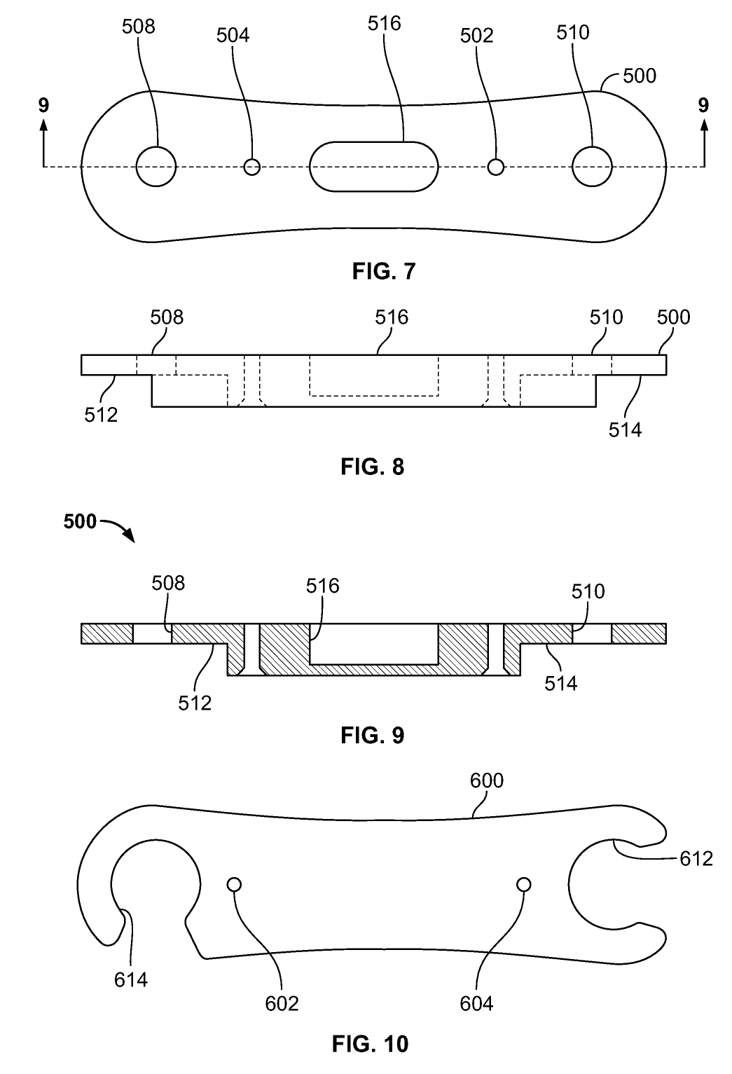

FIGS. 3A and 3B are exploded perspective views of an example fuel tank latch 100, which may include a cover plate 300 (see also FIGS. 4 and 5), a latch 400 (see also FIG. 6), a base plate 500 (see also FIGS. 7-9), and/or an attachment plate 600 (see also FIG. 10). In some example embodiments, cover plate 300, base plate 500, and/or attachment plate 600 may be substantially rigidly affixed to one another, such as by connectors 108, 110. Connector 108 may extend through holes 302, 502, 602 and/or slot 402. Connector 110 may extend through holes 304, 504, 604 and/or slot 404. In some example embodiments, connectors 108, 110 may include screws, rivets, bolts, and/or other similar fasteners. For example, connectors 108, 110 may comprise screws which may be threadedly received in holes 302, 304 in cover plate 300.

Latch 400 may be generally longitudinally slidably disposed with respect to cover plate 300, base plate 500, and/or attachment plate 600, such as between cover plate 300 and base plate 500 and/or in a longitudinal groove 306 of cover plate 300. Connectors 108, 110 may extend through slots 402, 404 of latch 400, which may be sized to allow the desired range of longitudinal motion of latch 400. Bolt 106 may be mounted to latch 400 (e.g., at hole 412) and/or may extend through a slot 312 in cover plate 300, where it may be threaded into knob 106A. Thus, while moving knob 106A and underlying attached latch 400 through the range of motion of bolt 106 in slot 312 of the cover plate 300, the connectors 108, 110 may move through the range of motion allowed in slots 402, 404 of latch 400. Consequently this allows keyhole slots 408, 410 to interact with pins 208, 206 of the chassis 210, respectively. Head 106B of bolt 106 may be received within slot 516. Latch 400 may be biased by a spring 400A (which may act between slot 516 and head 106B) towards the latching position such that the narrow portions 408A, 410A of the keyhole slots 408, 410 engage the pins, 206, 208, respectively, when external forces are removed.

Cover plate 300 and/or base plate 500 may include holes 308, 508 and holes 310, 510 configured to engage receiving pins 206, 208, respectively. Keyhole slots 408, 410 may be configured so that the narrow portions 408A, 410A of the keyhole slots 408, 410 latch to pins 206, 208, respectively, such as by fitting engaging circumferential grooves 216, 218 respectively, when the latch is slid to a latching position. The range of longitudinal motion that slots 402, 404 allow with respect to connectors 108, 110, respectively, may allow the keyhole slots 408, 410 to either fit in the circumferential grooves 216, 218, respectively, or to slide to allow the wider portions 408B, 410B of the keyhole slots 408, 410 to surround the pins 206, 208. Once the wider portions 408B, 410B of the keyhole slots 408, 410 surround the receiving pins 206, 208, the fuel tank latch 100 may move generally axially along the pins 206, 208, thus allowing engagement and/or disengagement from the pins 206, 208.

Base plate 500 may include generally circular cutout areas 512, 514 proximate opposite ends. While in the engaged position, circular cutout areas 512, 514 may receive mounts 202, 204, respectively. Attachment plate 600 may include a partially enclosed end with a longitudinally oriented opening 612 and/or a partially enclosed end with a laterally oriented opening 614. The laterally oriented opening 614 may be oriented about 90 degrees with respect to the longitudinally oriented opening 612.

To attach fuel tank latch 100 to the fuel tank 200, longitudinally oriented opening 612 of attachment plate 600 may be slid under mount 202. As the opening 612 of the attachment plate 600 is slid under mount 202, the circular cutout area 512 of base plate 500 may fit generally concentrically against the top of mount 202; thus, mount 202 may lie be between attachment plate 600 and base plate 500. Next, the partially enclosed end with the laterally oriented opening 614 of attachment plate 600 may be slid under mount 204, resulting in circular cutout area 514 of base plate 500 fitting generally concentrically against the top of mount 204.

FIG. 4 is plan view of an example fuel tank latch cover plate 300. This view shows that slot 312 may be offset from the center of cover plate 300, such as closer to hole 310. Slot 312 may allow bolt 106 (which may be attached to latch 400) to slide within grove 306 causing keyhole slots 408, 410 to interact with receiving pins 206, 208.

An example fuel tank latch 100 according to at least some aspects of the present disclosure may be configured to releaseably couple a first mount 202 and a second mount 204 associated with a fuel tank 200 to a first receiving pin 206 and a second receiving pin 208 associated with a chassis 210. An example fuel tank latch 100 may include an attachment plate 600 including a generally longitudinally oriented opening 612 configured to engage a first mount 202 associated with a fuel tank 200 and a generally laterally oriented opening 614 disposed substantially opposite of the generally longitudinally oriented opening 614 and configured to engage a second mount 204 associated with the fuel tank 200, the attachment plate 600 being substantially flat; a base plate 500 substantially rigidly mounted to the attachment plate 600; a cover plate 300 substantially rigidly mounted to the base plate 500; and a latch 400 longitudinally slidably disposed with between the base plate 500 and the cover plate 300, the latch 400 including a first keyhole slot 408 configured to selectively engage a first receiving pin 206 extending from a chassis 210 and a second keyhole slot 410 configured to selectively engage a second receiving pin 208 extending from the chassis 210.

An example method of installing a fuel tank latch 100 according to at least some aspects of the present disclosure may include engaging a first end 102 of a fuel tank latch 100 with a first mount 202 associated with a fuel tank 200; and engaging a second end 104 of the fuel tank latch 100 with a second mount 204 associated with the fuel tank 200 by pivoting the fuel tank latch 100 about the first mount 202.

An example method of operating a fuel tank latch 100 according to at least some aspects of the present disclosure may include pivoting a fuel tank 200 to engage a first mount 202 and a second mount 204 disposed on the fuel tank 200 with a first receiving pin 206 and a second receiving pin 208 disposed on a chassis 210, respectively; engaging a latch 400 of a fuel tank latch 100 with the first receiving pin 206 and the second receiving pin 208, the fuel tank latch 100 being mounted to the first mount 202 and the second mount 204; disengaging the latch 400 from the first receiving pin 206 and the second receiving pin 208 by sliding the latch 400 using a knob 106A mounted to the latch 400 and extending outward from the fuel tank latch 100; pivoting the fuel tank 200 to disengage the first mount 202 and the second mount 204 from the first receiving pin 206 and the second receiving pin 208, respectively.

All dimensions and angles provided in the accompanying drawings are merely exemplary and are not to be considered limiting in any way.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. A fuel tank latch configured to releaseably couple a first mount and a second mount associated with a fuel tank to a first receiving pin and a second receiving pin associated with a chassis, the fuel tank latch comprising:
an attachment plate including a generally longitudinally oriented opening configured to engage a first mount associated with a fuel tank and a generally laterally oriented opening disposed substantially opposite of the generally longitudinally oriented opening and configured to engage a second mount associated with the fuel tank, the attachment plate being substantially flat;
a base plate substantially rigidly mounted to the attachment plate;
a cover plate substantially rigidly mounted to the base plate; and
a latch longitudinally slidably disposed with between the base plate and the cover plate, the latch including a first keyhole slot configured to selectively engage a first receiving pin extending from a chassis and a second keyhole slot configured to selectively engage a second receiving pin extending from the chassis.

2. The fuel tank latch of claim 1, wherein:
the cover plate includes a generally longitudinally oriented slot, and
a knob mounted to the latch and extending outward through the slot of the cover plate.

3. The fuel tank latch of claim 1, further including:
at least one fastener extending through and coupling together the cover plate, the latch, the base plate, and the attachment plate;
wherein the at least one fastener extends through a generally longitudinally oriented slot in the latch to permit limited longitudinal movement of the latch.

4. The fuel tank latch of claim 1, wherein:
the base plate includes a first cutout for receiving at least a portion of the first mount therein, and a second cutout for receiving at least a portion of the second mount therein.

5. The fuel tank latch of claim 1, wherein:
the first keyhole slot is configured to releaseably engage a first generally circumferential groove in the first receiving pin; and
where the second keyhole slot is configured to releaseably engage a second generally circumferential groove in the second receiving pin.

6. The fuel tank latch of claim 1, wherein:
each of the first and second keyhole slots includes a narrow portion and a widened portion; and
the fuel tank latch further including a spring arranged to bias the latch generally towards the widened portions of the first and second keyhole slots.

7. A method of installing a fuel tank latch including:
engaging a first end of a fuel tank latch with a first mount associated with a fuel tank; and
engaging a second end of the fuel tank latch with a second mount associated with the fuel tank by pivoting the fuel tank latch about the first mount.

8. The method of claim 7, wherein:
engaging the first end of the fuel tank latch with the first mount includes receiving the first mount in a generally longitudinally oriented opening associated with the first end of the fuel tank latch.

9. The method of claim 7, wherein:
engaging the second end of the fuel tank latch with the second mount includes receiving the second mount in a generally laterally oriented opening associated with the second end of the fuel tank latch.

10. A method of operating a fuel tank latch including:
pivoting a fuel tank to engage a first mount and a second mount disposed on the fuel tank with a first receiving pin and a second receiving pin disposed on a chassis, respectively;
engaging a latch of the fuel tank latch with the first receiving pin and the second receiving pin, the fuel tank latch being mounted to the first mount and the second mount;
disengaging the latch from the first receiving pin and the second receiving pin by sliding the latch using a knob mounted to the latch and extending outward from the fuel tank latch;
pivoting the fuel tank to disengage the first mount and the second mount from the first receiving pin and the second receiving pin, respectively.

11. The method of claim 10, wherein engaging the latch of the fuel tank latch with the first receiving pin and the second receiving pin further includes:
sliding the latch to a disengaged position, receiving at least a portion of the first receiving pin and at least a portion of the second receiving pin within the fuel tank latch; and
sliding the latch to an engaged position in which the latch is releaseably secured to the first receiving pin and the second receiving pin.
